(19) United States
(12) Patent Application Publication
(10) Pub. No.: US 2024/0429530 A1
(43) Pub. Date: Dec. 26, 2024

(54) ENERGY STORAGE POWER SUPPLY

(71) Applicant: Sungrow (Shanghai) Co., Ltd., Shanghai (CN)

(72) Inventors: Meina Li, Hefei (CN); Junjie Mao, Hefei (CN); Zeyu Xiang, Hefei (CN)

(73) Assignee: Sungrow (Shanghai) Co., Ltd., Shanghai (CN)

(21) Appl. No.: 18/512,591

(22) Filed: Nov. 17, 2023

(30) Foreign Application Priority Data
Jun. 21, 2023 (CN) 202321619208.2

(51) Int. Cl. H01M 50/258; H01M 10/42; H01M 50/296; H01M 50/298; H01M 50/502

(52) U.S. Cl. CPC H01M 50/258; H01M 10/425; H01M 50/296; H01M 50/298; H01M 50/502

(57) ABSTRACT

An energy storage power supply includes an energy storage inverter and multiple battery modules, and the multiple battery modules are arranged in any horizontal direction and are connected in series and/or in parallel with each other, the energy storage inverter is arranged above any one of the multiple battery modules, and the energy storage inverter is connected in series and/or in parallel with the battery module arranged below the energy storage inverter. The energy storage power supply realizes a conversion between direct current and alternating current by connecting the energy storage inverter and the multiple battery modules in series and/or in parallel with each other, and reduces an overall height of the energy storage power supply by arranging the battery modules and a base in any horizontal direction, which facilitates subsequent overhaul and maintenance.

### CROSS REFERENCE TO RELATED APPLICATIONS

This application claims the priorities to Chinese patent application No. 202321619208.2, titled “ENERGY STORAGE POWER SUPPLY”, filed with the China National Intellectual Property Administration Jun. 21, 2023, the entire disclosure of which is hereby incorporated by reference.

### FIELD

The application relates to the technical field of an energy storage battery, and in particular to an energy storage power supply.

### BACKGROUND

An energy storage power supply is a product of the new era. With a continuous improvement of people's living standards, people's requirements for all aspects are increasing. In order to meet demand for emergency treatment and outdoor electricity, increasing requirements have been placed on the capacity of the energy storage power supply.

In the conventional technology, several of the battery modules in the energy storage power supply are generally stacked in an up-and-down direction, and all of the battery modules are connected in series or in parallel with each other, so as to improve the capacity of the energy storage power supply. However, in order to ensure an operation for each of the battery modules, it is necessary to reserve a large space between each of the battery modules so as to stack the battery modules in the up-and-down direction, which leads to a large overall height of the energy storage power supply, causing the energy storage power supply being easy to fall over and having potential safety hazards. In addition, in a case that a single battery module in the energy storage power supply is damaged and needs to be replaced, it is difficult to disassemble the battery modules stacked in the up-and-down direction because of their high stacking height, which is inconvenient for subsequent overhaul and maintenance.

Therefore, it is desire to provide an energy storage power supply to solve the above problems.

### SUMMARY

An object of the application is to provide an energy storage power supply with a reduced overall height, which is convenient for disassembly and assembly, and facilitates subsequent overhaul and maintenance.

In order to achieve the above object, the following technical solutions are provided according to the application.

An energy storage power supply includes:
an energy storage inverter; and
multiple battery modules, and the multiple battery modules are arranged in any horizontal direction and are connected in series and/or in parallel with each other, the energy storage inverter is arranged above any one of the battery modules, and the energy storage inverter is connected in series and/or in parallel with the battery modules arranged below the energy storage inverter.

In a preferred embodiment, the energy storage power supply further includes:
a connection cables; and
a connection terminal, which is arranged at a positive interface and a negative interface of the battery module and/or of the energy storage inverter, and the connection cables is configured to connect the multiple battery modules in series and/or in parallel with each other, and is further configured to connect the energy storage inverter in series and/or in parallel with the battery modules arranged below the energy storage inverter.

In a preferred embodiment, the connection terminal includes:
a terminal main body;
a first connection plug rotatably mounted at one end of the terminal main body, and the first connection plug is configured to be rotatably butted with the connection cables; and
a second connection plug rotatably mounted at the other end of the terminal main body, and the second connection plug is configured to be rotatably butted with the positive interface and/or the negative interface.

In a preferred embodiment, the second connection plug is connected with the terminal main body through a universal connection manner.

In a preferred embodiment, multiple first grooves are arranged on a sidewall of the first connection plug spaced apart, and the first grooves are configured for increasing friction between a hand and the sidewall of the first connection plug, and multiple second grooves are arranged on a sidewall of the second connection plug spaced apart, and the second grooves are configured for increasing the friction between the hand and the second connection plug.

In a preferred embodiment, an output end of the second connection plug is provided with rotating teeth, input ends of the positive interface and the negative interface are provided with rotating grooves, and the rotating teeth are configured to be rotatably engaged with the rotating grooves.

In a preferred embodiment, both of the connection cables and the connection terminal have waterproof capability, an outer periphery of the connection cables is wrapped with a waterproof rubber layer, and waterproof gaskets are arranged on the first connection plug and the second connection plug respectively.

In a preferred embodiment, the energy storage power supply further includes:
a protective housing which is mounted on the outer periphery of the battery module, and the outer periphery of the energy storage inverter and the battery module as a whole, and a gap is provided between an inner cavity side wall of the protective housing and the battery module and the energy storage inverter, and the connection cables and the connection terminal are accommodated in the gap.

In a preferred embodiment, the energy storage power supply further includes:
a base, and the battery module is arranged above the base, and each battery module is arranged corresponding to one base; multiple footrests are arranged on a lower end surface of the base and spaced apart, a lower portion of each footrest abuts against the ground, and each footrest is configured to drive the base to move in the vertical direction.

In a preferred embodiment, a wall hanging groove is arranged on a sidewall of the base, and the wall hanging groove is configured to be butted and fixed with a suspended wall hanging protrusion.

The beneficial effects according to the application are as follows.

The energy storage power supply provided according to the application realizes a conversion between direct current and alternating current by connecting the energy storage inverter and the battery module in series and/or in parallel with each other and connecting the multiple battery modules in series and/or in parallel with each other. Moreover, different number of the battery modules can be connected in series or in parallel with each other based on the actual demand, so as to adjust the output power supply and output current, thus meeting different electricity demand. By tiling the battery modules and a base in any horizontal direction, the overall height of the energy storage power supply is reduced, which facilitates subsequent overhaul and maintenance.

### BRIEF DESCRIPTION OF THE DRAWINGS

FIG. 1 is a schematic structural view of an energy storage power supply provided according to a first embodiment of the application;

FIG. 2 is a first schematic structural view of a connection terminal provided according to a first embodiment of the application;

FIG. 3 is a second schematic structural view of a connection terminal provided according to a first embodiment of the application;

Reference numerals in the drawings are listed as follows:
1000 energy storage power supply;
100 energy storage inverter;
200 battery module;
300 base;
310 footrest;
400 connection cables;
500 connection terminal; 510 first connection plug; 511 first groove; 520 second connection plug; 521 rotating teeth; 522 second groove; 530 terminal main body;
600 protective housing.

### DETAILED DESCRIPTION OF THE EMBODIMENTS

In order to make the technical problems solved by the application, the technical solutions adopted and the technical effects achieved are more clear, the technical solutions of the application is further explained below in conjunction with the drawings and embodiments.

In the description of the application, it should be pointed out that, terms “link”, “connect” and “fix” should be understood broadly, unless otherwise specifically defined. For example, it can be fixedly connected or detachably connected or integrally connected; it can be mechanically connected or electrically connected; it can be directly connected or indirectly connected through intermediate media, or inner parts of two components are in communication with each other, or the interaction between the two components. For those skilled in the art, the specific meaning of the above terms in the application may be understood in the light of specific circumstances.

In the application, unless otherwise specified and limited, the first feature “on” or “under” the second feature may include direct contact between the first and second features, and may also include that the first and second features are not in direct contact but through another feature contact between them. Furthermore, “above”, “over” and “on” the second feature includes that the first feature is directly above and obliquely above the second feature, or simply indicates that the first feature is higher in horizontal height than the second feature. The fact that the first feature is “below”, “under” and “down” the second feature includes that the first feature is directly below and obliquely below the second feature, or simply means that the first feature is lower in horizontal height than the second feature.

In the description of this embodiment, the orientation or positional relationships indicated by terms “up”, “down”, “left”, “right” and the like are based on the orientation or positional relationships shown in the drawings, and are merely for the convenience of describing the application and the simplification of the operation, and do not indicate or imply that the device or element referred to must be in a particular orientation, or be constructed and operated in a particular orientation, and therefore should not be construed as a limit to the scope of the application. In addition, the terms “first” and “second” are only used to distinguish them in description, and have no special meaning.

### First Embodiment

In order to meet demand for emergency treatment and outdoor electricity, increasing requirements have been placed on the capacity of the energy storage power supply. In the conventional technology, several of the battery modules in the energy storage power supply are generally stacked in an up-and-down direction, and all of the battery modules are connected in series or in parallel, so as to improve the capacity of the energy storage power supply. However, in order to ensure an operation for each of the battery modules, it is necessary to reserve a large space between each of the battery modules so as to stack the battery modules in the up-and-down direction, which leads to a large overall height of the energy storage power supply, causing the energy storage power supply being easy to fall over and having potential safety hazards. In addition, in a case that a single battery module in the energy storage power supply is damaged and needs to be replaced, it is difficult to disassemble the battery modules stacked in an up-and-down direction because of their high stacking height, which is inconvenient for subsequent overhaul and maintenance.

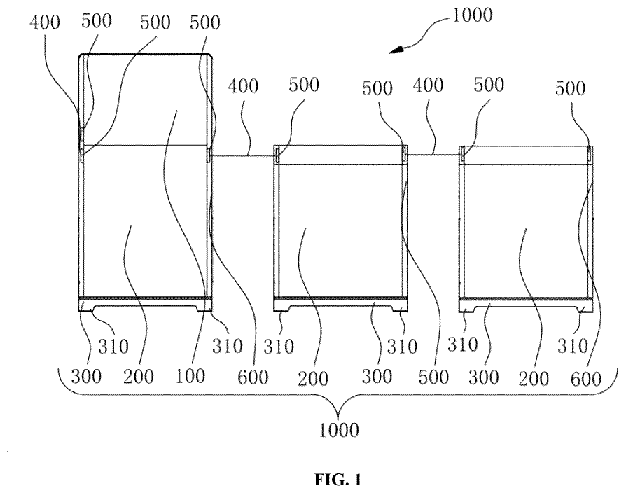

In order to solve the above problems, as shown in FIG. 1, an energy storage power supply 1000 is provided according to an embodiment of the application. The energy storage power supply 1000 includes an energy storage inverter 100 and multiple battery modules 200, and the multiple battery modules 200 are arranged in any horizontal direction and are connected in series and/or in parallel with each other, the energy storage inverter 100 is arranged above any one of the battery modules 200, and the energy storage inverter 100 is connected in series and/or in parallel with the battery modules 200 arranged below the energy storage inverter 100. The energy storage power supply 1000 realizes a conversion between direct current and alternating current by connecting the energy storage inverter 100 and the battery module 200 in series and/or in parallel with each other and connecting the multiple battery modules 200 in series and/or in parallel with each other. Moreover, different number of the battery modules 200 can be connected in series or in parallel with each other based on the actual demand, so as to adjust the output power supply and output current, thus meeting different electricity demand. By arranging the battery modules and a base in any horizontal direction, the overall height of the energy storage power supply is reduced, which facilitates subsequent overhaul and maintenance.

It should be noted that in this embodiment, three battery modules 200 are connected in series in the energy storage power supply 1000, and the energy storage inverter 100 is connected in series with the three battery modules 200. In other embodiments, the specific number of the battery modules 200, the connection manner between the battery modules 200, and the connection manner between the battery modules 200 and the energy storage inverter 100 in the energy storage power supply 1000 can be determined based on actual needs, which is not be specifically limited in this embodiment.

In addition, each of the battery modules 200 is equipped with a BCU (Battery Control Unit), which can monitor various operating parameters (temperature, voltage, current, state of charge and the like) of the battery module 200 in real time, and adjust current and voltage by using an optimization algorithm to improve a service life of the battery module 200. The specific structures and working principles of BCU and energy storage inverter 100 belong to the conventional technology, and is not be described here.

Further, the energy storage power supply 1000 further includes a connection cables 400 and a connection terminal 500, and the connection terminal 500 is arranged at a positive interface and a negative interface of the battery module 200 and/or the energy storage inverter 100, the connection cables 400 is configured to connect three battery modules 200 in series with each other, and the connection cables 400 is further configured to connect the energy storage inverter 100 in series with the battery module 200 arranged below the energy storage inverter 100. The energy storage inverter 100 is connected with the three battery modules 200 in series by arranging the connection cables 400 and the connection terminal 500, which is convenient to assemble and disassemble and further improves the assembly efficiency of the energy storage power supply 1000. It should be noted that in this embodiment, in order to improve the electrical connection effect of the connection cables 400 to the battery modules 200 and the energy storage inverter 100 and the electrical connection effect between the multiple battery modules 200, two ends of the connection cables 400 each is provided with one connection terminal 500.

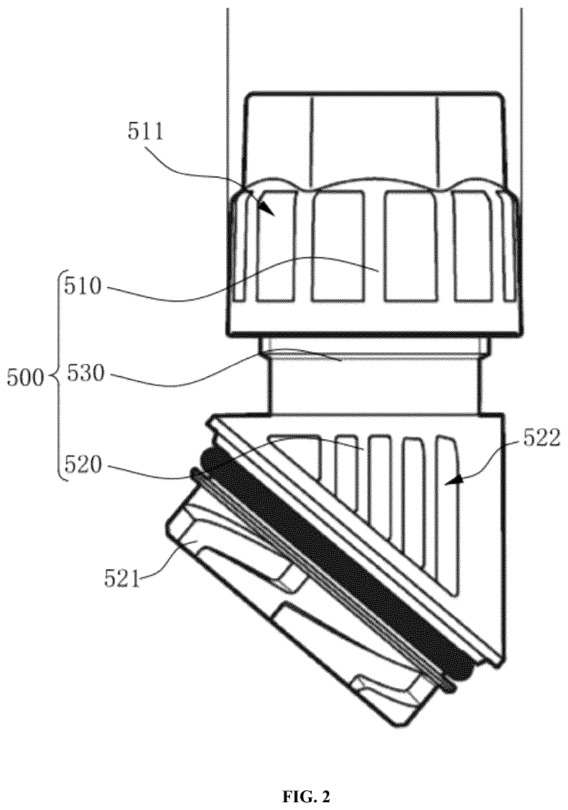

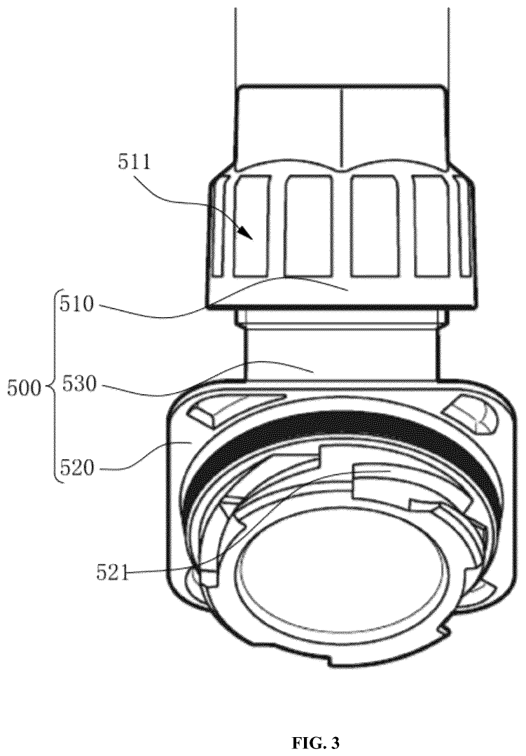

The specific structure of the connection terminal 500 is described with reference to FIG. 2 and FIG. 3. The connection terminal 500 includes a first connection plug 510, a second connection plug 520 and a terminal main body 530, and the first connection plug 510 is rotatably mounted at one end of the terminal main body 530 and is rotatably butted with the connection cables 400, and the second connection plug 520 is rotatably mounted at the other end of the terminal main body 530 and is butted with the positive interface and/or the negative interface, and the connection is not only convenient but also stable.

Further, the second connection plug 520 is connected with the terminal main body 530 through a universal connection manner. Specifically, in this embodiment, the second connection plug 520 is connected with the terminal main body 530 through a ball hinge connection manner to realize the universal connection. An end of the terminal main body 530 is provided with a ball pin, an end of the second connection plug 520 is provided with a ball seat, and the ball pin is rotatable along a spherical surface of the ball seat, so that rotation requirements under various conditions between the second connection plug 520 and the terminal main body 530 can be met, and the flexibility is high, thus an efficiency of mounting the second connection plug 520 with the positive interface and/or the negative interface is improved. Moreover, by rotating the second connection plug 520, the problem that the connection cables 400 is directly bent due to the position setting of the energy storage inverter 100 and/or the battery module 200 during the assembly of the energy storage power supply 1000 can be avoided, and the protection for the connection cables 400 is improved. In addition, since it is convenient to adjust a relative angle between the second connection plug 520 and the positive interface and/or the negative interface, when the battery modules 200 are arranged and mounted in a large scale, multiple battery modules 200 are configured to be arranged at any position in a horizontal plane, and any two of the battery modules 200 can be connected with each other by the connection cables through the universal rotation of the second connection plug 520 and the terminal main body 530, so that the battery modules 200 can be laid and expanded in any horizontal direction. In other embodiments, the ball seat may be arranged at the end of the terminal main body 530, and the ball pin may be arranged at the end of the second connection plug 520, which is not be specifically limited in this embodiment.

It can be understood that in this embodiment, the second connection plug 520 is connected with the terminal main body 530 through the ball hinge manner to realize the universal connection. In other embodiments, the second connection plug 520 is rotatably connected with the terminal main body 530 through a universal joint structure or other universal connection structures, as long as the second connection plug 520 can rotate in any direction relative to the terminal main body 530, which is not specifically limited in this embodiment.

Further, an output end of the second connection plug 520 is provided with rotating teeth 521, an input end of the positive interface and/or the negative interface is provided with rotating grooves, and the rotating teeth 521 are configured to be rotatably engaged with the rotating grooves. It should be noted that in this embodiment, an outer peripheral wall of the output end of the second connection plug 520 is provided with the rotating teeth 521, an inner cavity wall of the input end of the positive interface and/or negative interface is provided with the rotating grooves, and the second connection plug 520 is rotatably inserted into the positive interface and/or negative interface. In other embodiments, the rotating teeth 521 may be provided on the inner cavity wall of the output end of the second connection plug 520, the rotating grooves may be provided on the outer peripheral walls of the input ends of the positive interface and/or negative interface, and the positive interface and/or negative interface are rotatably inserted into the second connection plug 520, which is not be specifically limited in this embodiment.

In order to further facilitate the rotation of the first connection plug 510 and the second connection plug 520, multiple first grooves 511 are arranged on a sidewall of the first connection plug 510 and spaced apart, and the first grooves 511 are configured for increasing friction between a hand and the sidewall of the first connection plug 510. The sidewall of the second connection plug 520 is provided with multiple second grooves 522 spaced apart, and the second grooves 522 are configured for increasing the friction between the hand and the second connection plug 520.

In addition, both of the connection cables 400 and the connection terminal 500 have waterproof capability. Specifically, an outer surface of the terminal main body 530 is coated with a waterproof material, and an outer periphery of the connection cables 400 is mounted with a waterproof rubber layer, which can seal and wrap the connection cables. Waterproof gaskets are arranged on the inner cavity wall of the first connection plug 510 and the outer peripheral wall of the second connection plug 520 in the connection terminal 500 respectively. When the first connection plug 510 is rotatably butted and fixed with the connection cables 400, the waterproof gasket in the first connection plug 510 is configured to be sandwiched between the inner cavity wall of the first connection plug 510 and the rubber layer at the outer periphery of the connection cables 400, thus an effect of sealing and waterproofing is achieved. When the second connection plug 520 is rotatably butted and fixed with the positive interface and/or the negative interface, the waterproof gasket in the second connection plug 520 is configured to be sandwiched between the outer peripheral wall of the second connection plug 520 and the inner cavity wall of the positive interface and/or the negative interface, thus the effect of sealing and waterproofing is achieved.

Preferably, the energy storage power supply 1000 further includes a protective housing 600, where the protective housing 600 is mounted outside the outer periphery of the battery module 200 and the energy storage inverter 100 and the battery module 200 as a whole. There is a gap between an inner cavity sidewall of the protective housing 600 and the battery module 200 and the energy storage inverter 100, and the connection terminal 500 is accommodated in the gap. In this energy storage power supply 1000, the protective housing 600 is arranged on the outer periphery of the battery module 200 and the battery module 200 and the energy storage inverter 100 as a whole, which not only can further improve the protection for the energy storage inverter 100 and the battery module 200, but also can accommodate the connection terminal 500, thus the aesthetic appearance is improved.

Preferably, the energy storage power supply further includes a base 300, and the battery module 200 is arranged above the base 300, and each of the battery modules 200 is arranged corresponding to one base 300. Multiple footrests 310 are arranged on a lower end face of the base 300 and spaced apart, and a lower portion of each footrest 310 abuts against the ground, and each footrest 310 is configured to drive the base 300 to move in the vertical direction. By placing the battery module 200 on the base 300, the waterproof protection for the battery module 200 is realized, and by adjusting and arranging the footrests 310 at different positions to drive the battery module 200 on the base 300 to move in the vertical direction, thus a leveling of the base 300 can be realized, and the application range of the base 300 can be improved. Specifically, in this embodiment, the base 300 is a square plate, and four corners of the square plate each is provided with the footrest 310. The footrest 310 is threaded through the square plate from top to bottom and then abut against the ground. When the square plate needs to be leveled, the footrest 310 at the corresponding position is screwed, and the corner of the square plate connected with the footrest 310 may move up and down under a screw drive so as to realize the leveling of the square plate. In other embodiments, a telescopic sleeve may further be arranged between the footrest 310 and the square plate to level the square plate, which is not be specifically limited in this embodiment.

### Second Embodiment

The structure of the energy storage power supply 1000 disclosed in this embodiment is generally the same as that of the first embodiment. The difference between the arranged energy storage inductor 1000 disclosed in this embodiment and the first embodiment is that the specific structure of the base 300 is different.

In this embodiment, a side wall of the base 300 is provided with a wall hanging groove, and the wall hanging groove may be butted and fixed with a suspended wall hanging protrusion, so that the base 300, the battery module 200 and the energy storage inverter 100 are suspended and fixed, and the waterproof effect on the energy storage power supply 1000 is further improved.

Obviously, the above embodiments of the application are merely examples to clearly illustrate the application, and are not intended to limit the implementation of the application. For those of ordinary skill in the art, other changes or modifications in different forms can be made on the basis of the above description. It is unnecessary and impossible to list all the implementations here. Any modifications, equivalent substitutions or modifications made within the spirit and principle of the application shall fall within the protection scope of the application.

1. An energy storage power supply, comprising:
an energy storage inverter; and
a plurality of battery modules, wherein the plurality of battery modules are arranged in any horizontal direction and are connected in series and/or in parallel with each other, the energy storage inverter is arranged above any one of the plurality of battery modules, and the energy storage inverter is connected in series and/or in parallel with the battery module arranged below the energy storage inverter.

2. The energy storage power supply according to claim 1, further comprising:
a connection cables; and
a connection terminal, which is arranged at a positive interface and a negative interface of the battery module and/or of the energy storage inverter, wherein the connection cables is configured to connect the plurality of battery modules in series and/or in parallel with each other, and is further configured to connect the energy storage inverter in series and/or in parallel with the battery module arranged below the energy storage inverter.

3. The energy storage power supply according to claim 2, wherein the connection terminal comprises:
a terminal main body;
a first connection plug rotatably mounted at one end of the terminal main body, and the first connection plug is configured to be rotatably butted with the connection cables; and
a second connection plug rotatably mounted at the other end of the terminal main body, and the second connection plug is configured to be rotatably butted with the positive interface and/or the negative interface.

4. The energy storage power supply according to claim 3, wherein the second connection plug is rotatably connected with the terminal main body through a universal connection manner.

5. The energy storage power supply according to claim 3, wherein a plurality of first grooves are arranged on a sidewall of the first connection plug and spaced apart, the first grooves being configured to increase friction between a hand and the sidewall of the first connection plug, and wherein a plurality of second grooves are arranged on a sidewall of the second connection plug and spaced apart, the second grooves being configured to increase the friction between the hand and the second connection plug.

6. The energy storage power supply according to claim 3, wherein an output end of the second connection plug is provided with rotating teeth, input ends of the positive interface and the negative interface are provided with rotating grooves, and the rotating teeth are configured to be rotatably engaged with the rotating grooves.

7. The energy storage power supply according to claim 3, wherein both of the connection cables and the connection terminal have waterproof capability, an outer periphery of the connection cables is wrapped with a waterproof rubber layer, and waterproof gaskets are arranged on the first connection plug and the second connection plug respectively.

8. The energy storage power supply according to claim 3, further comprising:
a protective housing which is mounted outside the outer periphery of the battery module and the outer periphery of the energy storage inverter and the battery module as a whole, wherein a gap is provided between an inner cavity sidewall of the protective housing and the battery module and the energy storage inverter, and the connection terminal is accommodated in the gap.

9. The energy storage power supply according to claim 1, further comprising:
a base, wherein the battery module is arranged above the base, each battery module is arranged corresponding to one base, a plurality of footrests are arranged on a lower end face of the base and spaced apart, a lower portion of each footrest abuts against the ground, and each footrest is configured to drive the base to move in the vertical direction.

10. The energy storage power supply according to claim 9, wherein a wall hanging groove is arranged on a sidewall of the base, and the wall hanging groove is configured to be butted and fixed with a wall hanging protrusion arranged in a suspended manner.
